(19) United States
(12) Patent Application Publication
(10) Pub. No.: US 2020/0305031 A1
(43) Pub. Date: Sep. 24, 2020

(54) BROADCAST SIGNAL RECEPTION METHOD USING NETWORK SWITCHING AND APPARATUS FOR THE SAME

(71) Applicant: ELECTRONICS AND TELECOMMUNICATIONS RESEARCH INSTITUTE, Daejeon (KR)

(72) Inventors: Jae-Young LEE, Daejeon (KR); Sung-Ik PARK, Daejeon (KR); Heung-Mook KIM, Daejeon (KR); Hyun-Jeong YIM, Sejong-si (KR)

(73) Assignee: ELECTRONICS AND TELECOMMUNICATIONS RESEARCH INSTITUTE, Daejeon (KR)

(21) Appl. No.: 16/659,714

(22) Filed: Oct. 22, 2019

(30) Foreign Application Priority Data
Mar. 19, 2019 (KR) 10-2019-0030896

(51) Int. Cl. H04W 36/00; H04W 36/14; H04W 36/30; H04L 12/26; H04B 17/336

(52) U.S. Cl. CPC H04W 36/0011; H04W 36/14; H04W 36/0085; H04N 21/64322; H04L 43/0829; H04B 17/336; H04W 36/30

(57) ABSTRACT

Disclosed herein are a broadcast signal reception method using network switching and an apparatus for the same. The broadcast signal reception method using network switching includes determining, by a broadcast signal reception apparatus, a network-switching time point based on a network-switching condition that is set in consideration of at least one of a characteristics of a broadcast signal received over a broadcast network during a preset time period and a continuity of packets received over the broadcast network during the preset time period, and receiving, by the broadcast signal reception apparatus, the broadcast signal by performing network switching to a broadband network at the network-switching time point.

### CROSS REFERENCE TO RELATED APPLICATION

This application claims the benefit of Korean Patent Application No. 10-2019-0030896, filed Mar. 19, 2019, which is hereby incorporated by reference in its entirety into this application.

### BACKGROUND OF THE INVENTION

### 1. Technical Field

The present invention relates generally to broadcast signal reception technology, and more particularly, to technology that can seamlessly provide a broadcasting service in a broadcasting environment in which a digital broadcast network and a broadband network are operable in conjunction with each other.

### 2. Description of the Related Art

With the development of recent broadcasting and communication technology, research into technology based on which two different types of networks are operated in conjunction with each other to provide a service has been conducted.

Because Advanced Television Systems Committee (ATSC) 3.0, which is the next-generation broadcasting standard, adopts an Internet Protocol (IP)-based broadcasting scheme, it is suitable for a service in which both a broadcast network and a broadband network are utilized. However, in order to provide a single service over two or more networks, there are many cases in which it is difficult to guarantee seamless communication when switching from one network to another.

### PRIOR ART DOCUMENTS

### Patent Documents

(Patent Document 1)

Korean Patent Application Publication No. 10-2015-0001914, Date of Publication: Jan. 7, 2015 (Title: Method and Apparatus for Supporting Handover of Contents in Mobile Broadcast and Broadband network”)

### SUMMARY OF THE INVENTION

Accordingly, the present invention has been made keeping in mind the above problems occurring in the prior art, and an object of the present invention is to provide a seamless broadcasting service in an environment in which a broadcast network and a broadband network are used.

Another object of the present invention is to seamlessly implement convergence, cooperation, handoff, etc., which utilize a broadband network in ATSC-3.0-based broadcasting.

In accordance with an aspect of the present invention to accomplish the above objects, there is provided a broadcast signal reception method using network switching, including determining, by a broadcast signal reception apparatus, a network-switching time point based on a network-switching condition that is set in consideration of at least one of a characteristics of a broadcast signal received over a broadcast network during a preset time period and a continuity of packets received over the broadcast network during the preset time period; and receiving, by the broadcast signal reception apparatus, the broadcast signal by performing network switching to a broadband network at the network-switching time point.

The characteristics of the broadcast signal may include a signal strength and a Signal-to-Noise Ratio (SNR), and the continuity of the packets includes information about whether audio/video packets are continuously received.

Determining the network-switching time point may be configured to determine that the network-switching condition is satisfied when a current state corresponds to at least one of a case where the signal strength becomes less than a preset reference signal strength, a case where the SNR becomes lower than a preset reference SNR, and a case where the audio/video packets are not continuously received.

Receiving the broadcast signal may include, when packet loss attributable to the broadcast network occurs, requesting a lost packet from a broadcasting server based on the broadband network, receiving the lost packet in a unicast manner, and then recovering the packet loss.

The broadcast signal reception method may further include, when the SNR becomes higher than the preset reference SNR while the signal strength is greater than the preset reference signal strength after the network switching, performing, by the broadcast signal reception apparatus, network re-switching to the broadcast network.

Performing the network re-switching may be configured to perform the network re-switching in additional consideration of the information about whether the audio/video packets are continuously received.

The broadcast signal reception method may further include performing time synchronization between the broadcast signal reception apparatus and at least one server and at least one transmission module for transmitting the broadcast signal and the packets.

In accordance with another aspect of the present invention to accomplish the above objects, there is provided a broadcast signal reception apparatus, including a processor for determining a network-switching time point based on a network-switching condition that is set in consideration of at least one of characteristics of a broadcast signal received over a broadcast network during a preset time period and a continuity of packets received over the broadcast network during the preset time period, performing network switching to a broadband network at the network-switching time point, and then receiving the broadcast signal, and a memory for storing the network-switching condition.

The characteristics of the broadcast signal may include a signal strength and a Signal-to-Noise Ratio (SNR), and the continuity of the packets includes information about whether audio/video packets are continuously received.

The processor may be configured to determine that the network-switching condition is satisfied when a current state corresponds to at least one of a case where the signal strength becomes less than a preset reference signal strength, a case where the SNR becomes lower than a preset reference SNR, and a case where the audio/video packets are not continuously received.

The processor may be configured to, when packet loss attributable to the broadcast network occurs, request a lost packet from a broadcasting server based on the broadband network, receive the lost packet in a unicast manner, and then recover the packet loss.

The processor may be configured to, when the SNR becomes higher than the preset reference SNR while the signal strength is greater than the preset reference signal strength after the network switching, perform network re-switching to the broadcast network.

The processor may be configured to perform the network re-switching in additional consideration of the information about whether the audio/video packets are continuously received.

The processor may be configured to perform time synchronization between the broadcast signal reception apparatus and at least one server and at least one transmission module for transmitting the broadcast signal and the packets.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating a broadcast signal reception system using network switching according to an embodiment of the present invention;

FIG. 2 is an operation flowchart illustrating a broadcast signal reception method using network switching according to an embodiment of the present invention;

FIG. 3 is a diagram illustrating an example of switching between a broadcast network and a broadband network according to the present invention;

FIG. 4 is a diagram illustrating an example in which a lost packet is received over a broadband network according to the present invention;

FIG. 5 is a flow diagram illustrating in detail a network switching process according to an embodiment of the present invention;

FIG. 6 is a flow diagram illustrating in detail a network re-switching process according to an embodiment of the present invention;

FIG. 7 is a flow diagram illustrating in detail a lost packet acquisition process according to an embodiment of the present invention;

FIG. 8 is a block diagram illustrating a broadcast signal reception apparatus according to an embodiment of the present invention; and

FIG. 9 is a diagram illustrating a computer system according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

In the present specification, it should be understood that terms such as “include” or “have” are merely intended to indicate that features, numbers, steps, operations, components, parts, or combinations thereof are present, and are not intended to exclude the possibility that one or more other features, numbers, steps, operations, components, parts, or combinations thereof will be present or added.

Hereinafter, preferred embodiments of the present invention will be described in detail with reference to the attached drawings.

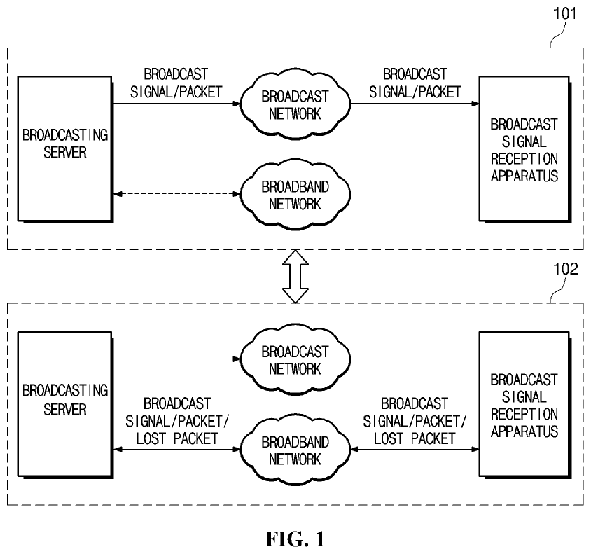

FIG. 1 is a diagram illustrating a broadcast signal reception system using network switching according to an embodiment of the present invention.

Referring to FIG. 1, cases to which the broadcast signal reception system using network switching according to an embodiment of the present invention is applied may be classified into the case 101 where a broadcast network is used and the case 102 where a broadband network is used through network switching.

First, a broadcast signal reception apparatus in the case 101 where the broadcast network is used determines a network-switching time point based on a network-switching condition that is set in consideration of at least one of the characteristics of a broadcast signal and the continuity of packets. Here, the broadcast signal characteristics may mean the characteristics of the broadcast signal received over the broadcast network during a preset time period, and the packet continuity may mean the continuity of packets received over the broadcast network during the preset time period.

Here, the broadcast signal characteristics may include signal strength and a Signal-to-Noise Ratio (SNR), and the packet continuity may include information about whether audio/video packets are continuously received.

In this case, when the current state corresponds to at least one of the case where signal strength becomes less than a preset reference (threshold) signal strength, the case where an SNR becomes lower than a preset reference SNR, and the case where audio/video packets are not continuously received, it may be determined that the network-switching condition is satisfied.

Thereafter, the broadcast signal reception apparatus in the case 101 where the broadcast network is used receives the broadcast signal by performing network switching to the broadband network at the network-switching time point.

Thereafter, the broadcast signal reception apparatus in the case 102 where the broadband network is used may request a lost packet from a broadcasting server based on the broadband network when packet loss attributable to the broadcast network occurs, may receive the lost packet in a unicast manner, and may then recover packet loss.

When the SNR of a broadcast signal, transmitted over the broadcast network, becomes higher than the preset reference SNR while the signal strength of the broadcast signal is greater than the preset reference signal strength after network switching to the broadband network, the broadcast signal reception apparatus may perform network re-switching to the broadcast network.

Here, the network re-switching may also be performed in additional consideration of information about whether audio/video packets are continuously received.

Here, both in the case 101 where the broadcast network is used and in the case 102 where the broadband network is used through network switching, time synchronization may be performed between the broadcast signal reception apparatus and at least one server and at least one transmission module for transmitting the broadcast signal and the packets.

In this way, network switching is performed by monitoring, in real time, physical-layer parameters and Audio/Video (A/V) signal packets, and thus a seamless broadcasting service may be provided.

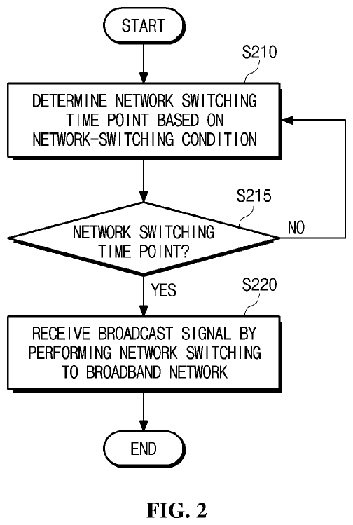

FIG. 2 is an operation flowchart illustrating a broadcast signal reception method using network switching according to an embodiment of the present invention.

Referring to FIG. 2, in the broadcast signal reception method using network switching according to an embodiment of the present invention, a broadcast signal reception apparatus determines a network-switching time point based on a network-switching condition that is set in consideration of at least one of the characteristics of a broadcast signal received over the broadcast network during a preset time period and the continuity of packets received over the broadcast network during the preset time period at step S210.

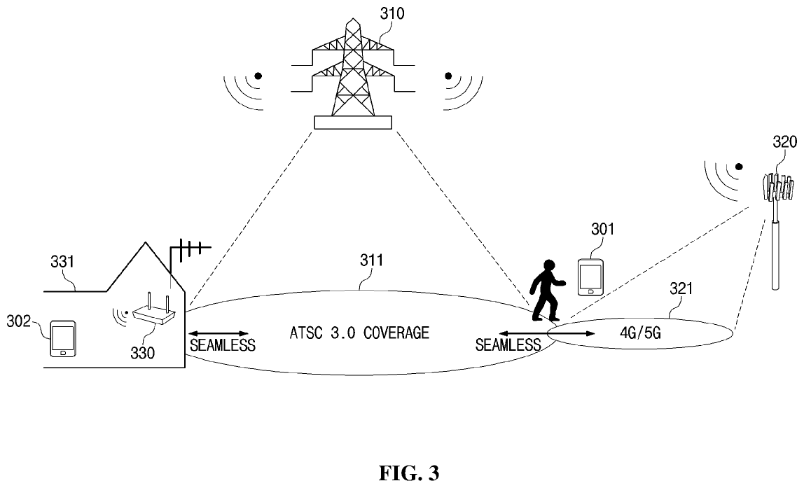

For example, referring to FIG. 3, a broadcast network service based on a broadcast network transmission apparatus 310 that utilizes a high-power/high-tower structure may transmit a broadcast signal to broadcast network coverage 311, but it may be difficult to receive a broadcast signal in an indoor area. Therefore, in the indoor area, as illustrated in FIG. 3, the broadcast signal may be transmitted to a broadcast signal reception apparatus 302 through a Wi-Fi network using a broadband network transmission apparatus 330, such as a home gateway. Also, even in an outdoor area, there may occur the situation in which a user who carries a broadcast signal reception apparatus 301 moves out of the area of the broadcast network coverage 311. Thus, in this case, the corresponding service may be provided using a broadband network transmission apparatus 320 corresponding to a mobile base station, such as for 4G/5G communication.

In this way, when a single service is to be provided over multiple networks (e.g. networks for broadcasting, mobile communication, Wi-Fi, etc.), there is a need to perform seamless network switching that enables a service to be provided seamlessly from the aspect of a viewer who watches broadcasting through a broadcast signal reception apparatus, and thus the present invention intends to propose a method for such a seamless service.

Here, the broadcast signal characteristics may include signal strength and a Signal-to-Noise Ratio (SNR), and the packet continuity may include information about whether audio/video packets are continuously received.

That is, the broadcast signal reception apparatus may predict the time point at which a broadcast signal will be actually interrupted by monitoring, in real time, physical-layer parameters, such as the signal strength or SNR of the broadcast signal that is transferred over the broadcast network, or by monitoring, in real time, whether audio/video packets are continuously received.

In this case, when the current state corresponds to at least one of the case where signal strength becomes less than a preset reference (threshold) signal strength, the case where the SNR becomes lower than a preset reference SNR, and the case where audio/video packets are not continuously received, it may be determined that the network-switching condition is satisfied.

At this time, the case where the signal strength becomes less than the preset reference (threshold) signal strength may include the case where the signal strength is less than or equal to the preset reference signal strength, and the case where the SNR becomes lower than the preset reference SNR may include the case where the SNR is lower than or equal to the preset reference SNR.

If it is determined at step S215 that the current time point is the network-switching time point, the broadcast signal reception apparatus receives the broadcast signal by performing network switching to the broadband network at step S220.

For example, when only the signal strength and SNR of the broadcast signal received over the broadcast network are taken into consideration, network switching from the broadcast network to the broadband network may be performed based on the following [Logic 1]:

If (SS≤SS_thr) OR (SNR≤SNR_thr) for Time_Period [Logic 1]

Switch to Broadband

Here, SS denotes signal strength, SS_thr denotes the threshold value of signal strength, SNR may denote a Signal-to-Noise Ratio (SNR), SNR_thr denotes the threshold value of SNR, and Time_Period denotes a time period.

Here, each of SS_thr, SNR_thr, and Time_Period may be set and changed through the broadcast signal reception apparatus.

For example, in the case of a system in which an ATSC 3.0 broadcasting mode is operated at SNR=5 dB, the broadcast signal reception apparatus inputs the value of SNR_thr as 6 dB, thus enabling seamless network switching from the broadcast network to the broadband network before the broadcast signal is actually interrupted. Similarly, the value of SS_thr may be set to a value higher than the minimum signal strength operating in the broadcast signal reception apparatus depending on a physical-layer mode, thus enabling seamless network switching from the broadcast network to the broadband network.

Here, a Time_Period condition is input, so that, when the corresponding condition is satisfied during a specific time period in which a broadcast signal is input, network switching to the broadband network may be performed.

In another example, when information about whether audio/video packets are continuously received, together with the signal strength and SNR of the broadcast signal received over the broadcast network, is additionally taken into consideration, network switching from the broadcast network to the broadband network may be performed based on the following [Logic 2]:

If (SS≤SS_thr) OR (SNR≤SNR_thr) OR (A/V Out) for Time_Period [Logic 2]

Switch to Broadband

Here, A/V Out may denote the case where the loss of audio/video packets is detected in the buffer of the broadcast signal reception apparatus, that is, the case where audio/video packets are not continuously received over the broadcast network.

Here, when packet loss attributable to the broadcast network occurs, a lost packet may be requested from the broadcasting server based on the broadband network, and may be received in a unicast manner, and thus packet loss may be recovered.

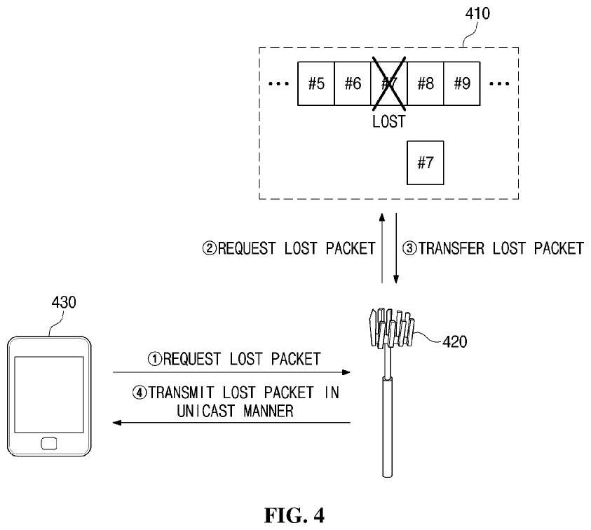

For example, in the coverage edge and shadow area of an ATSC 3.0 broadcast network and a mobile environment, interruption of broadcast signals may occur, and at this time, IP packet loss may occur. Therefore, as illustrated in FIG. 4, in the present invention, a broadcast signal reception apparatus 430 may request a lost IP packet attributable to the broadcast network from a broadcasting server 410 through a broadband network transmission apparatus 420, and only the lost packet may be transmitted over the broadband network in a unicast manner, thus providing a seamless service.

Such a broadcast network/broadband network cooperation service may also be provided at an A/V frame level, as well as at a Multi-mode Mobile Terminal/Internet Protocol (MMT/IP) (or a router/IP) level. That is, when an A/V frame sequence lost due to the broadcast network is found and requested based on the broadband network, the broadcasting server 410 may provide an IP packet including the requested A/V frame sequence in a unicast manner over the broadband network.

Here, if it is determined at step S215 that the current time point is not a network-switching time point, monitoring may be continuously performed, and thus whether the current time point is a network-switching time point may be determined.

Further, although not illustrated in FIG. 2, in the broadcast signal reception method using network switching according to an embodiment of the present invention, when the SNR of a broadcast signal becomes higher than the preset reference SNR while the signal strength of the broadcast signal is greater than the preset reference signal strength after network switching, the broadcast signal reception apparatus may perform network re-switching to the broadcast network. That is, when the quality of a signal transferred over the broadcast network is improved, network re-switching from the broadband network to the broadcast network may be performed.

At this time, the case where the signal strength becomes greater than the preset reference signal strength may include the case where the signal strength is equal to or greater than the preset reference signal strength, and the case where the SNR becomes higher than the preset reference SNR may include the case where the SNR is equal to or higher than the preset reference SNR.

For example, network re-switching to the broadcast network may be performed based on the following [Logic 3]:

If (SS>SS_thr) AND (SNR>SNR_thr) for Time_Period [Logic 3]

Switch to Broadcast

Here, similar to network switching, network re-switching may be seamlessly performed by monitoring the SNR and signal strength in real time.

Here, network re-switching may also be performed in additional consideration of information about whether audio/video packets are continuously received.

For example, network re-switching may be performed in consideration of information about whether audio/video packets are continuously received based on the following [Logic 4]:

If (SS>SS_thr) AND (SNR>SNR_thr) AND (A/V On) for Time_Period [Logic 4]

Switch to Broadcast

Here, A/V On may denote the case where it is detected, by the buffer of the broadcast signal reception apparatus, that audio/video packets are continuously received over the broadcast network.

Further, although not illustrated in FIG. 2, in the broadcast signal reception method using network switching according to an embodiment of the present invention, time synchronization may be performed between the broadcast signal reception apparatus and at least one server and at least one transmission module for transmitting the broadcast signal and the packets.

For example, when all of an A/V player, a signaling server, an A/V encoder, an IP multiplexer, a broadcast gateway, and a transmitter that are used in a studio and a television tower may be operated in a time-synchronized manner, time synchronization may be performed using a Network Time Protocol (NTP), a Precision Time Protocol (PTP), a Global Positioning System (GPS), or the like. In this case, the broadcast signal reception apparatus may also perform time synchronization using a GPS or a broadband network protocol (e.g. NTP, PTP, or the like), and may search the broadcast network or the broadband network for a required IP packet or an A/V frame through a Presentation Time Stamp (PTS) set by the studio. This configuration may also be used for seamless service switching between the broadcast network and the broadband network.

Further, although not illustrated in FIG. 2, the broadcast signal reception method using network switching according to an embodiment of the present invention may store various types of information, generated during the broadcast signal reception process according to an embodiment of the present invention, in a separate storage module, as described above.

By means of the broadcast signal reception method using network switching according to the embodiment of the present invention, a seamless broadcasting service may be provided in an environment in which a broadcast network and a broadband network are used.

Also, convergence, cooperation, handoff, etc., which utilize a broadband network, may be seamlessly implemented in ATSC 3.0-based broadcasting.

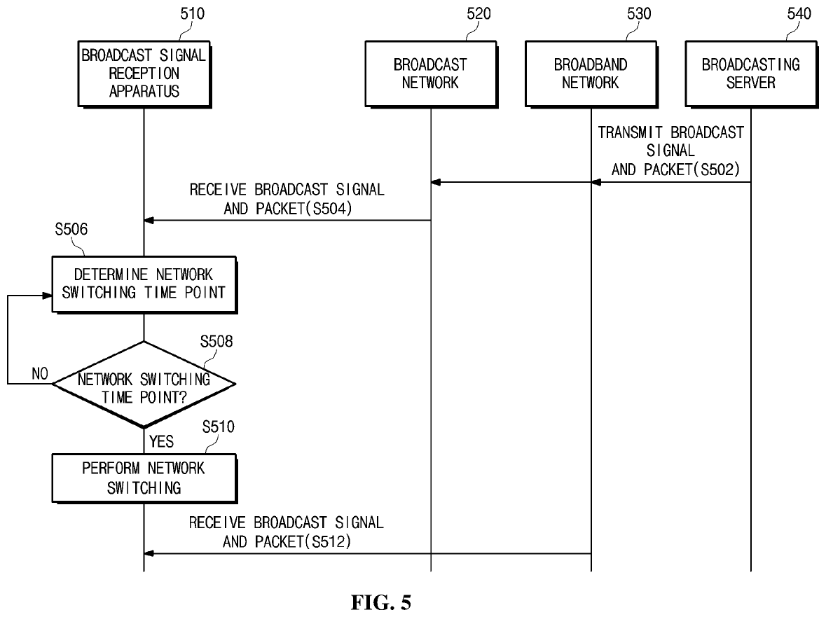

FIG. 5 is a flow diagram illustrating in detail a network switching process according to an embodiment of the present invention.

Referring to FIG. 5, first, a broadcasting server 540 may configure an environment in which a broadcast signal may be provided to a broadcast signal reception apparatus 510 over a broadcast network 520 or a broadband network 530 by transmitting the broadcast signal and a packet to each of the broadcast network 520 and the broadband network 530 at step S502.

Next, the broadcast signal reception apparatus 510 may receive the broadcast signal and the packet over the broadcast network 520 at step S504.

Thereafter, the broadcast signal reception apparatus 510 may determine a network-switching time point based on a preset network-switching condition at step S506.

In this case, the network-switching condition may be set in consideration of at least one of the characteristics of a broadcast signal received during a preset time period and the continuity of packets received during the preset time period.

Thereafter, if it is determined at step S508 that the current time point is the network-switching time point, the broadcast signal reception apparatus 510 may perform network switching at step S510, and may then receive a broadcast signal and a packet over the broadband network 530 at step S512.

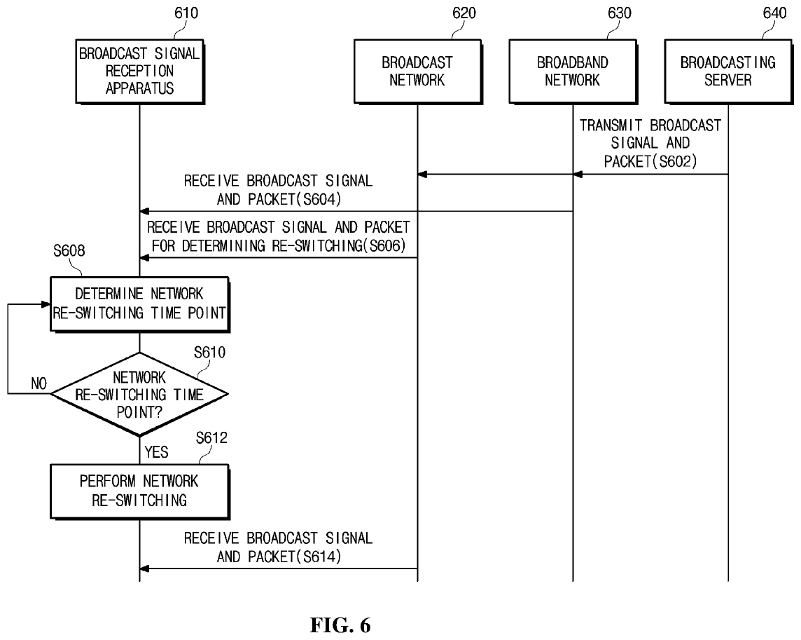

FIG. 6 is a flow diagram illustrating in detail a network re-switching process according to an embodiment of the present invention.

Referring to FIG. 6, first, a broadcasting server 640 may configure an environment in which a broadcast signal may be provided to a broadcast signal reception apparatus 610 over a broadcast network 620 or a broadband network 630 by transmitting the broadcast signal and a packet to each of the broadcast network 620 and the broadband network 630 at step S602.

In this case, as illustrated in FIG. 6, if it is assumed that the broadcast signal reception apparatus 610 has already been receiving the broadcast signal and the packet from the broadband network 630 through network switching at step S604, the broadcast signal reception apparatus 610 may receive the broadcast signal and the packet from the broadcast network 620 so as to determine network re-switching in the future at step S606.

Thereafter, the broadcast signal reception apparatus 610 may determine a network re-switching time point based on the broadcast signal and the packet received from the broadcast network 620 at step S608.

Here, when the SNR of the broadcast signal received from the broadcast network 620 becomes higher than a preset reference SNR while the signal strength of the broadcast signal is greater than a preset reference signal strength, it may be determined that the current time point is a network re-switching time point. Also, the network re-switching time point may also be determined in additional consideration of information about whether audio/video packets are continuously received from the broadcast network 620.

Thereafter, if it is determined at step S610 that the current time point is the network re-switching time point, the broadcast signal reception apparatus 610 performs network re-switching at step S612, and may then receive again a broadcast signal and a packet over the broadcast network 620 at step S614.

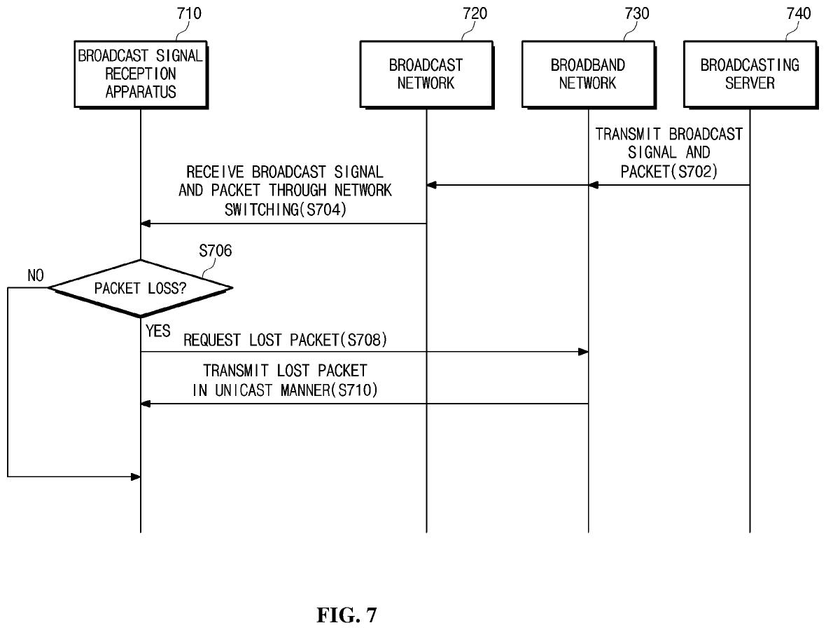

FIG. 7 is a flow diagram illustrating in detail a lost packet acquisition process according to an embodiment of the present invention.

Referring to FIG. 7, first, a broadcasting server 740 may configure an environment in which a broadcast signal may be provided to a broadcast signal reception apparatus 710 over a broadcast network 720 or a broadband network 730 by transmitting the broadcast signal and a packet to each of the broadcast network 720 and the broadband network 730 at step S702.

In this case, as illustrated in FIG. 7, if it is assumed that the broadcast signal reception apparatus 710 has already been receiving the broadcast signal and the packet from the broadband network 730 through network switching at step S704, whether packet loss has occurred through the broadcast network 720 during network switching or before network switching may be determined at step S706.

If it is determined at step S706 that packet loss has occurred, the broadcast signal reception apparatus 710 may request a lost packet from the broadband network 730 at step S708.

Thereafter, the broadcast signal reception apparatus 710 may recover the packet loss by receiving the lost packet in a unicast manner from the broadband network 730 at step S710.

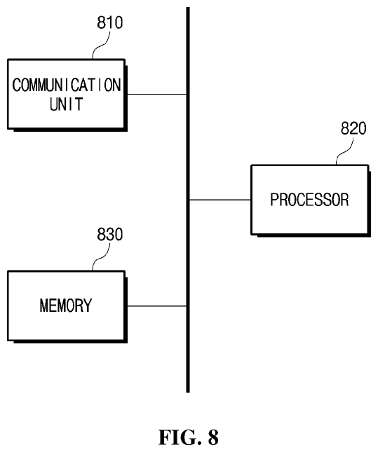

FIG. 8 is a block diagram illustrating a broadcast signal reception apparatus according to an embodiment of the present invention.

Referring to FIG. 8, the broadcast signal reception apparatus according to an embodiment of the present invention may include a communication unit 810, a processor 820, and memory 830.

The communication unit 810 may function to transmit/receive information required in order to receive a broadcast signal over a broadband network such as a typical network. In particular, the communication unit 810 according to an embodiment of the present invention may send a message for requesting a lost packet from a broadcasting server when packet loss occurs, and may receive the lost packet in response to the request.

The processor 820 determines a network-switching time point based on a network-switching condition that is set in consideration of at least one of the characteristics of a broadcast signal received over the broadcast network during a preset time period and the continuity of packets received over the broadcast network during a preset time period.

For example, referring to FIG. 3, a broadcast network service based on a broadcast network transmission apparatus 310 that utilizes a high-power/high-tower structure may transmit a broadcast signal to broadcast network coverage 311, but it may be difficult to receive a broadcast signal in an indoor area. Therefore, in the indoor area, as illustrated in FIG. 3, the broadcast signal may be transmitted to a broadcast signal reception apparatus 302 through a Wi-Fi network using a broadband network transmission apparatus 330, such as a home gateway. Also, even in an outdoor area, there may occur the situation in which a user who carries a broadcast signal reception apparatus 301 moves out of the area of the broadcast network coverage 311. Thus, in this case, the corresponding service may be provided using a broadband network transmission apparatus 320 corresponding to a mobile base station, such as for 4G/5G communication.

In this way, when a single service is to be provided over multiple networks (e.g. networks for broadcasting, mobile communication, Wi-Fi, etc.), there is a need to perform seamless network switching that enables a service to be provided seamlessly from the aspect of a viewer who watches broadcasting through a broadcast signal reception apparatus, and thus the present invention intends to propose a method for such a seamless service.

Here, the broadcast signal characteristics may include signal strength and a Signal-to-Noise Ratio (SNR), and the packet continuity may include information about whether audio/video packets are continuously received.

That is, the broadcast signal reception apparatus may predict the time point at which a broadcast signal will be actually interrupted by monitoring, in real time, physical-layer parameters, such as the signal strength or SNR of the broadcast signal that is transferred over the broadcast network, or by monitoring, in real time, whether audio/video packets are continuously received.

In this case, when the current state corresponds to at least one of the case where signal strength becomes less than a preset reference (threshold) signal strength, the case where the SNR becomes lower than a preset reference (threshold) SNR, and the case where audio/video packets are not continuously received, it may be determined that the network-switching condition is satisfied.

At this time, the case where the signal strength becomes less than the preset reference signal strength may include the case where the signal strength is less than or equal to the preset reference signal strength, and the case where the SNR becomes lower than the preset reference SNR may include the case where the SNR is lower than or equal to the preset reference SNR.

Further, the processor 820 receives the broadcast signal by performing network switching to the broadband network at the network-switching time point.

For example, when only the signal strength and SNR of the broadcast signal received over the broadcast network are taken into consideration, network switching from the broadcast network to the broadband network may be performed based on the following [Logic 1]:

If (SS≤SS_thr) OR (SNR≤SNR_thr) for Time_Period [Logic 1]

Switch to Broadband

Here, SS denotes signal strength, SS_thr denotes the threshold value of signal strength, SNR may denote a Signal-to-Noise Ratio (SNR), SNR_thr denotes the threshold value of SNR, and Time_Period denotes a time period.

Here, each of SS_thr, SNR_thr, and Time_Period may be set and changed through the broadcast signal reception apparatus.

For example, in the case of a system in which an ATSC 3.0 broadcasting mode is operated at SNR=5 dB, the broadcast signal reception apparatus inputs the value of SNR_thr as 6 dB, thus enabling seamless network switching from the broadcast network to the broadband network before the broadcast signal is actually interrupted. Similarly, the value of SS_thr may be set to a value higher than the minimum signal strength operating in the broadcast signal reception apparatus depending on a physical-layer mode, thus enabling seamless network switching from the broadcast network to the broadband network.

Here, a Time_Period condition is input, so that, when the corresponding condition is satisfied during a specific time period in which a broadcast signal is input, network switching to the broadband network may be performed.

In another example, when information about whether audio/video packets are continuously received, together with the signal strength and SNR of the broadcast signal received over the broadcast network, is additionally taken into consideration, network switching from the broadcast network to the broadband network may be performed based on the following [Logic 2]:

If (SS≤SS_thr) OR (SNR≤SNR_thr) OR (A/V Out) for Time_Period [Logic 2]

Switch to Broadband

Here, A/V Out may denote the case where the loss of audio/video packets is detected in the buffer of the broadcast signal reception apparatus, that is, the case where audio/video packets are not continuously received over the broadcast network.

Here, when packet loss attributable to the broadcast network occurs, a lost packet may be requested from the broadcasting server based on the broadband network, and may be received in a unicast manner, and thus packet loss may be recovered.

For example, in the coverage edge and shadow area of an ATSC 3.0 broadcast network and a mobile environment, interruption of broadcast signals may occur, and at this time, IP packet loss may occur. Therefore, as illustrated in FIG. 4, in the present invention, a broadcast signal reception apparatus 430 may request a lost IP packet attributable to the broadcast network from a broadcasting server 410 through a broadband network transmission apparatus 420, and only the lost packet may be transmitted over the broadband network in a unicast manner, thus providing a seamless service.

Such a broadcast network/broadband network cooperation service may also be provided at an A/V frame level, as well as at a Multi-mode Mobile Terminal/Internet Protocol (MMT/IP) (or a router/IP) level. That is, when an A/V frame sequence lost due to the broadcast network is found and requested based on the broadband network, the broadcasting server 410 may provide an IP packet including the requested A/V frame sequence in a unicast manner over the broadband network.

Further, when the SNR of a broadcast signal becomes higher than the preset reference SNR while the signal strength of the broadcast signal is greater than the preset reference signal strength after network switching, the processor 820 may perform network re-switching to the broadcast network. That is, when the quality of a signal transferred over the broadcast network is improved, network re-switching from the broadband network to the broadcast network may be performed.

At this time, the case where the signal strength becomes greater than the preset reference signal strength may include the case where the signal strength is equal to or greater than the preset reference signal strength, and the case where the SNR becomes higher than the preset reference SNR may include the case where the SNR is equal to or higher than the preset reference SNR.

For example, network re-switching to the broadcast network may be performed based on the following [Logic 3]:

If (SS>SS_thr) AND (SNR>SNR_thr) for Time_Period [Logic 3]

Switch to Broadcast

Here, similar to network switching, network re-switching may be seamlessly performed by monitoring the SNR and signal strength in real time.

Here, network re-switching may also be performed in additional consideration of information about whether audio/video packets are continuously received.

For example, network re-switching may be performed in consideration of information about whether audio/video packets are continuously received based on the following [Logic 4]:

If (SS>SS_thr) AND (SNR>SNR_thr) AND (A/V On) for Time_Period [Logic 4]

Switch to Broadcast

Here, A/V On may denote the case where it is detected, by the buffer of the broadcast signal reception apparatus, that audio/video packets are continuously received over the broadcast network.

Further, the processor 820 may perform time synchronization between the broadcast signal reception apparatus and at least one server and at least one transmission module for transmitting the broadcast signal and the packets.

For example, when all of an A/V player, a signaling server, an A/V encoder, an IP multiplexer, a broadcast gateway, and a transmitter that are used in a studio and a television tower may be operated in a time-synchronized manner, time synchronization may be performed using a Network Time Protocol (NTP), a Precision Time Protocol (PTP), a Global Positioning System (GPS), or the like. In this case, the broadcast signal reception apparatus may also perform time synchronization using a GPS or a broadband network protocol (e.g. NTP, PTP, or the like), and may search the broadcast network or the broadband network for a required IP packet or an A/V frame through a Presentation Time Stamp (PTS) set by the studio. This configuration may also be used for seamless service switching between the broadcast network and the broadband network.

The memory 830 stores the network-switching condition.

Furthermore, the memory 830 may store various types of information generated during the broadcast signal reception process according to the embodiment of the present invention, as described above.

In accordance with an embodiment, the memory 830 may be configured independently of the broadcast signal reception apparatus, thus supporting a function for receiving broadcast signals. Here, the memory 830 may function as a separate large-capacity (mass) storage, and may include a control function for performing operations.

Meanwhile, the broadcast signal reception apparatus may be equipped with memory, and may internally store information in the apparatus. In an embodiment, the memory may be a computer-readable storage medium. In an embodiment, the memory may be a volatile memory unit, and in another embodiment, the memory may be a nonvolatile memory unit. In an embodiment, a storage device may be a computer-readable storage medium. In various different embodiments, the storage device may include, for example, a hard disk device, an optical disk device or any other mass storage device.

By utilizing the broadcast signal reception apparatus according to the embodiment of the present invention, a seamless broadcasting service may be provided in an environment in which a broadcast network and a broadband network are used.

Also, convergence, cooperation, handoff, etc., which utilize a broadband network, may be seamlessly implemented in ATSC 3.0-based broadcasting.

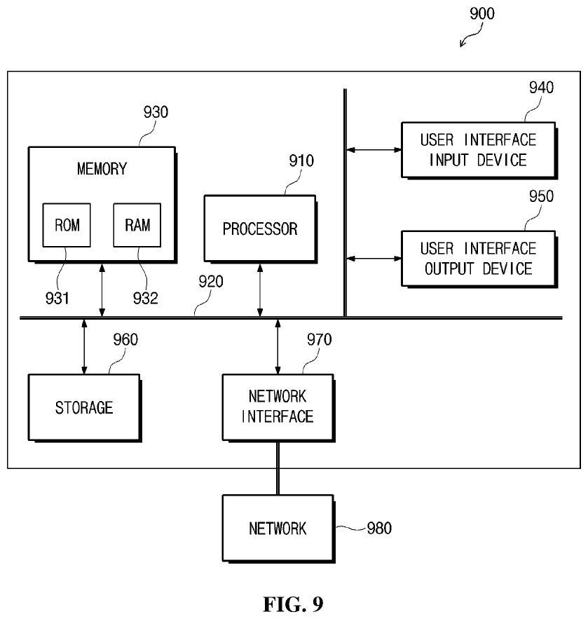

FIG. 9 is a diagram illustrating a computer system according to an embodiment of the present invention.

Referring to FIG. 9, the embodiment of the present invention may be implemented in a computer system such as a computer-readable storage medium. As illustrated in FIG. 9, a computer system 900 may include one or more processors 910, memory 930, a user interface input device 940, a user interface output device 950, and storage 960, which communicate with each other through a bus 920. The computer system 900 may further include a network interface 970 connected to a network 980. Each processor 910 may be a Central Processing Unit (CPU) or a semiconductor device for executing processing instructions stored in the memory 930 or the storage 960. Each of the memory 930 and the storage 960 may be any of various types of volatile or nonvolatile storage media. For example, the memory 930 may include Read-Only Memory (ROM) 931 or Random Access Memory (RAM) 932.

Therefore, the embodiment of the present invention may be implemented as a non-transitory computer-readable medium in which a computer-implemented method is recorded or in which computer-executable instructions are recorded. When the computer-executable instructions are executed by the processor, the instructions may perform the method according to at least one aspect of the present invention.

In accordance with the present invention, there can be provided a seamless broadcasting service in an environment in which a broadcast network and a broadband network are used.

Also, the present invention may seamlessly implement convergence, cooperation, handoff, etc., which utilize a broadband network, in ATSC 3.0-based broadcasting.

As described above, in the broadcast signal reception method and the apparatus for the method according to the present invention, the configurations and schemes in the above-described embodiments are not limitedly applied, and some or all of the above embodiments can be selectively combined and configured such that various modifications are possible.

What is claimed is:

1. A broadcast signal reception method using network switching, comprising:
determining, by a broadcast signal reception apparatus, a network-switching time point based on a network-switching condition that is set in consideration of at least one of a characteristics of a broadcast signal received over a broadcast network during a preset time period and a continuity of packets received over the broadcast network during the preset time period; and
receiving, by the broadcast signal reception apparatus, the broadcast signal by performing network switching to a broadband network at the network-switching time point.

2. The broadcast signal reception method of claim 1, wherein the characteristics of the broadcast signal include a signal strength and a Signal-to-Noise Ratio (SNR), and the continuity of the packets includes information about whether audio/video packets are continuously received.

3. The broadcast signal reception method of claim 2, wherein determining the network-switching time point is configured to determine that the network-switching condition is satisfied when a current state corresponds to at least one of a case where the signal strength becomes less than a preset reference signal strength, a case where the SNR becomes lower than a preset reference SNR, and a case where the audio/video packets are not continuously received.

4. The broadcast signal reception method of claim 1, wherein receiving the broadcast signal comprises, when packet loss attributable to the broadcast network occurs, requesting a lost packet from a broadcasting server based on the broadband network, receiving the lost packet in a unicast manner, and then recovering the packet loss.

5. The broadcast signal reception method of claim 3, further comprising, when the SNR becomes higher than the preset reference SNR while the signal strength is greater than the preset reference signal strength after the network switching, performing, by the broadcast signal reception apparatus, network re-switching to the broadcast network.

6. The broadcast signal reception method of claim 5, wherein performing the network re-switching is configured to perform the network re-switching in additional consideration of the information about whether the audio/video packets are continuously received.

7. The broadcast signal reception method of claim 1, further comprising performing time synchronization between the broadcast signal reception apparatus and at least one server and at least one transmission module for transmitting the broadcast signal and the packets.

8. A broadcast signal reception apparatus, comprising:
a processor for determining a network-switching time point based on a network-switching condition that is set in consideration of at least one of characteristics of a broadcast signal received over a broadcast network during a preset time period and a continuity of packets received over the broadcast network during the preset time period, performing network switching to a broadband network at the network-switching time point, and then receiving the broadcast signal; and
a memory for storing the network-switching condition.

9. The broadcast signal reception apparatus of claim 8, wherein the characteristics of the broadcast signal include a signal strength and a Signal-to-Noise Ratio (SNR), and the continuity of the packets includes information about whether audio/video packets are continuously received.

10. The broadcast signal reception apparatus of claim 9, wherein the processor is configured to determine that the network-switching condition is satisfied when a current state corresponds to at least one of a case where the signal strength becomes less than a preset reference signal strength, a case where the SNR becomes lower than a preset reference SNR, and a case where the audio/video packets are not continuously received.

11. The broadcast signal reception apparatus of claim 8, wherein the processor is configured to, when packet loss attributable to the broadcast network occurs, request a lost packet from a broadcasting server based on the broadband network, receive the lost packet in a unicast manner, and then recover the packet loss.

12. The broadcast signal reception apparatus of claim 10, wherein the processor is configured to, when the SNR becomes higher than the preset reference SNR while the signal strength is greater than the preset reference signal strength after the network switching, perform network re-switching to the broadcast network.

13. The broadcast signal reception apparatus of claim 12, wherein the processor is configured to perform the network re-switching in additional consideration of the information about whether the audio/video packets are continuously received.

14. The broadcast signal reception apparatus of claim 8, wherein the processor is configured to perform time synchronization between the broadcast signal reception apparatus and at least one server and at least one transmission module for transmitting the broadcast signal and the packets.
